(19) United States
(12) Patent Application Publication
(10) Pub. No.: US 2018/0370140 A1
(43) Pub. Date: Dec. 27, 2018

(54) THREE-DIMENSIONAL PRINTING APPARATUS

(71) Applicant: Roland DG Corporation, Hamamatsu-shi (JP)

(72) Inventor: Fumiyoshi IWASE, Hamamatsu-shi (JP)

(21) Appl. No.: 16/003,143

(22) Filed: Jun. 8, 2018

(30) Foreign Application Priority Data
Jun. 27, 2017 (JP) 2017-125393

(51) Int. Cl. B29C 64/364; B33Y 30/00; B33Y 40/00; B29C 64/209; B29C 64/245; B29C 64/393; B33Y 50/02; B29C 64/255

(52) U.S. Cl. CPC B29C 64/364; B33Y 30/00; B33Y 40/00; B29C 64/209; B29C 64/165; B29C 64/393; B33Y 50/02; B29C 64/255; B29C 64/245

(57) ABSTRACT

A three-dimensional printing apparatus includes a printing table, a line head, a conveyor, an air supplier, and a controller. The line head includes discharge holes disposed in a straight line in a first direction intersecting a scanning direction. The air supplier supplies air to a lower surface of the line head in a second direction intersecting the first direction such that the air is supplied from a rear side to a front side in the scanning direction when the line head moves relative to the printing table while discharging a curing liquid.

### CROSS REFERENCE TO RELATED APPLICATIONS

This application claims the benefit of priority to Japanese Patent Application No. 2017-125393 filed on Jun. 27, 2017. The entire contents of this application are hereby incorporated herein by reference.

### BACKGROUND OF THE INVENTION

### 1. Field of the Invention

The present invention relates generally to three-dimensional printing apparatuses, and in particular, to a three-dimensional printing apparatus to effect three-dimensional printing (which may hereinafter be referred to as “additive manufacturing”) using a powder material.

### 2. Description of the Related Art

A powder lamination manufacturing technique known in the related art involves: curing, with a curing liquid, a powder material spread into a thin layer so as to form each of cross-sectional layers; and sequentially stacking the cross-sectional layers so as to print a three-dimensional object. A three-dimensional printing apparatus to perform such an additive manufacturing method typically includes: a printing table to support a powder layer; a discharge head to discharge a curing liquid onto the powder layer; and a conveyor to move positions of the printing table and the discharge head relative to each other. In order to maintain printing accuracy at a desired level, a distance between the discharge head and the powder layer is set at about 2 mm to about 3 mm, for example. Thus, discharging the curing liquid onto the powder material in the course of performing the additive manufacturing method unfortunately causes a peripheral portion of the powder material to swirl up and adhere to the lower surface of the discharge head. The adhesion of the powder material to the discharge head may clog nozzle holes arranged in the lower surface of the discharge head. This prevents the discharge head from discharging the curing liquid properly. Such a defective condition may affect the quality of a resulting three-dimensional object. One solution to such problems is a method disclosed in JP 2011-212862 A, for example. The method disclosed in JP 2011-212862 A involves moving a discharge head in such a manner as to reduce the possibility of degrading the quality of a resulting three-dimensional object in the event of a defective condition in some of discharge holes of the discharge head.

As described above, the method disclosed in JP 2011-212862 A is intended to maintain the quality of a resulting three-dimensional object at a desired level if a powder material adheres to the discharge head. Examples of a powder material to be prepared, however, include a powder material containing a binder component in advance. If such a powder material is left adhering to the discharge head for a long period of time, the powder material will be firmly fixed to the lower surface of the discharge head. In such a case, the powder material cannot be easily removed from the lower surface of the discharge head by automatic maintenance performed afterward. A technique developed recently involves using a line head provided with a large number of nozzle holes arranged in a long line having a length approximately equal to the width of a printing region, so that the line head discharges a curing liquid onto a wide area at a time. Such a line head has a long length and is prone to catch swirling-up powder accordingly. Thus, a powder material is unfavorably more likely to adhere to such a line head than to a “shuttle head” (which may also be referred to as a “serial head”) having a length sufficiently shorter than the width of a printing region.

### SUMMARY OF THE INVENTION

Accordingly, preferred embodiments of the present invention provide three-dimensional printing apparatuses that effectively reduce or prevent adhesion of a powder material to a line head.

A preferred embodiment of the present invention provides a three-dimensional printing apparatus including a printing table, a line head, a conveyor, an air supplier, and a controller. A powder material is to be placed on the printing table. The line head is disposed above the printing table. The line head includes a lower surface provided with a plurality of discharge holes from which a curing liquid to bind particles of the powder material is to be discharged. The conveyor moves one of the printing table and the line head relative to the other one of the printing table and the line head in a scanning direction. The air supplier is disposed on the line head. The controller is configured or programmed to control driving of the air supplier. The discharge holes of the line head are disposed in a straight line in a first direction intersecting the scanning direction. The air supplier supplies air to the lower surface of the line head in a second direction intersecting the first direction such that the air is supplied from a rear side to a front side in the scanning direction when the line head moves relative to the printing table while discharging the curing liquid.

The three-dimensional printing apparatus described above operates such that the air supplier supplies air to the lower surface of the line head (i.e., to a space defined between the line head and the powder material placed on the printing table) so as to produce an air current. The air current carries away swirling-up particles of the powder material before the swirling-up particles of the powder material adhere to the lower surface of the line head. Thus, the three-dimensional printing apparatus reduces or prevents adhesion of the powder material to the line head.

A three-dimensional printing apparatus according to a preferred embodiment of the present invention effects printing with high accuracy while preventing a defective condition such as clogging of the discharge holes of the line head.

A three-dimensional printing apparatus according to a preferred embodiment of the present invention reduces the frequency of performing maintenance of the line head so as to increase the lifetime of the line head.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic cross-sectional view of a three-dimensional printing apparatus according to a preferred embodiment of the present invention.

FIG. 2 is a schematic plan view of a three-dimensional printing apparatus according to a preferred embodiment of the present invention.

FIG. 3 is a cross-sectional view of a line head, a flattener, and an air supplier according to a preferred embodiment of the present invention.

FIG. 4 is a block diagram of a controller according to a preferred embodiment of the present invention.

FIG. 5 is a schematic diagram illustrating how a curing liquid is discharged from a line head of a conventional three-dimensional printing apparatus.

FIG. 6 is a schematic diagram illustrating how a curing liquid is discharged from a line head of a three-dimensional printing apparatus according to a preferred embodiment of the present invention.

### DETAILED DESCRIPTION OF THE PREFERRED EMBODIMENTS

Preferred embodiments of the present invention will be described below with reference to the drawings. The preferred embodiments described below are naturally not intended to limit the present invention in any way. Components or elements having the same functions are identified by the same reference signs, and description thereof will be simplified or omitted when deemed redundant.

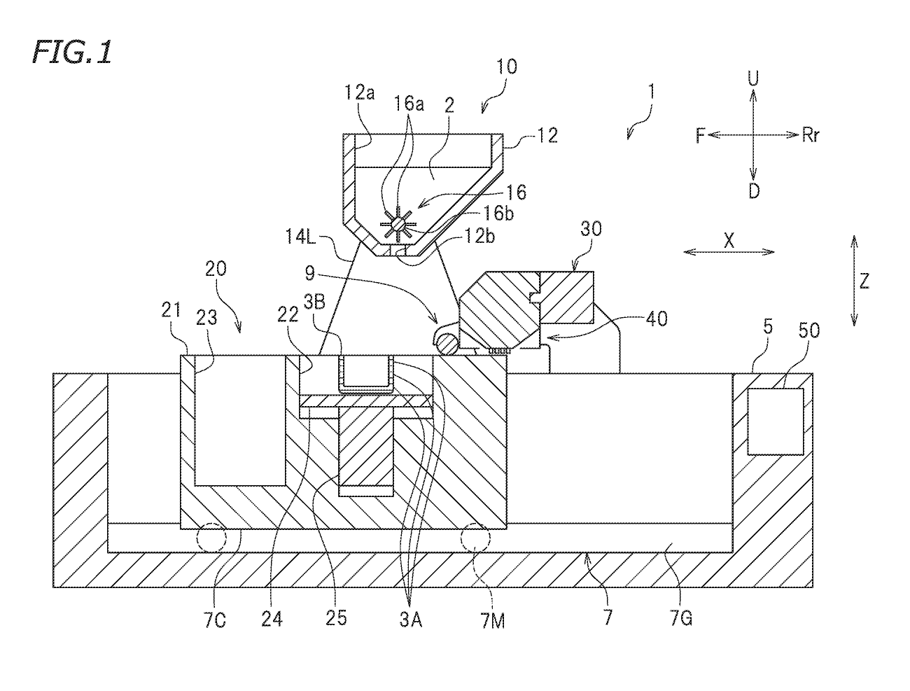

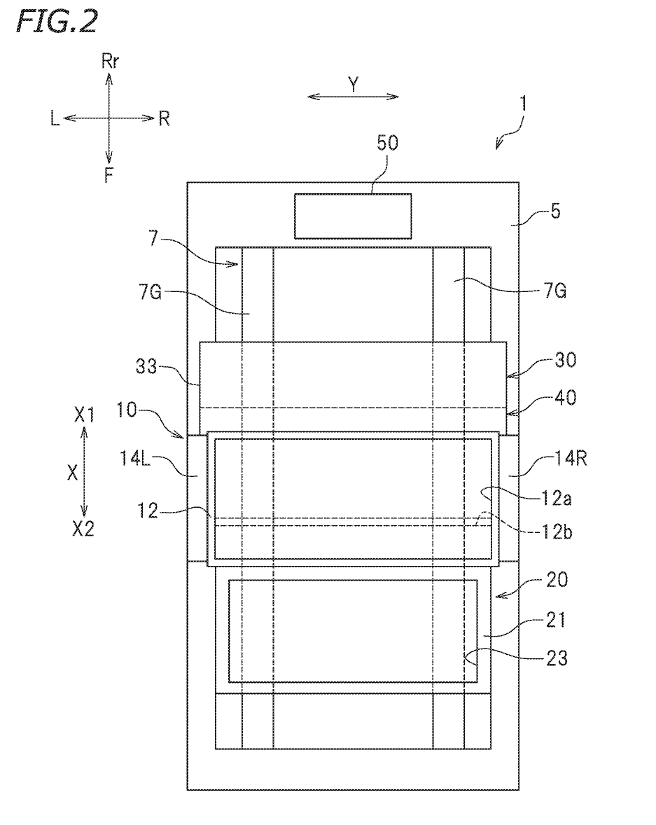

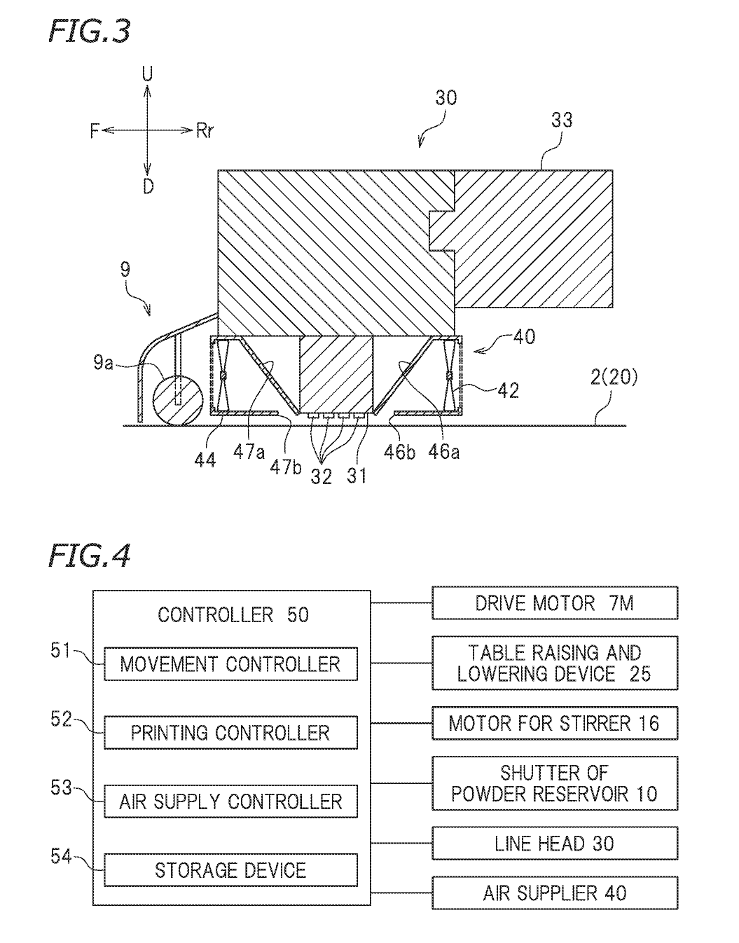

FIG. 1 is a cross-sectional view of a three-dimensional printing apparatus 1. FIG. 2 is a plan view of the three-dimensional printing apparatus 1. FIG. 3 is an enlarged cross-sectional view of a line head 30, a flattener 9, and an air supplier 40 (which will be described below). The reference signs F, Rr, R, L, U, and D in the drawings respectively represent front, rear, right, left, up, and down. The reference signs F, Rr, U, and D in the drawings may respectively represent a front side, a rear side, an upper side, and a lower side. The reference signs F, Rr, U, and D in the drawings may respectively represent a forward direction, a rearward direction, an upward direction, and a downward direction. The reference signs X, Y, and Z in the drawings respectively represent a front-rear direction, a right-left direction, and an up-down direction. The front-rear direction X corresponds to a scanning direction. The scanning direction X includes a first scanning direction and a second scanning direction. The up-down direction Z corresponds to a direction in which layers of a three-dimensional object are to be stacked. These directions are defined merely for the sake of convenience of description and do not limit in any way how the three-dimensional printing apparatus 1 may be structured or installed.

The three-dimensional printing apparatus 1 cures, with a curing liquid, a powder material 2 spread into a thin layer so as to form each of cross-sectional layers 3A. The three-dimensional printing apparatus 1 sequentially stacks the cross-sectional layers 3A in the up-down direction Z such that the cross-sectional layers 3A are integral with each other. Thus, the three-dimensional printing apparatus 1 prints a three-dimensional object 3B. The three-dimensional printing apparatus 1 according to the present preferred embodiment includes a body 5, a conveyor 7, a flattener 9, a powder reservoir 10, a printer 20, a line head 30, an air supplier 40, and a controller 50. The components of the three-dimensional printing apparatus 1 will be described in detail below.

The body 5 is an outer body of the three-dimensional printing apparatus 1. The body 5 is elongated in the scanning direction X. The body 5 has a box shape including an opening facing in the upward direction U. The body 5 holds the conveyor 7, the printer 20, and the controller 50. The body 5 also defines and functions as a support base supporting the powder reservoir 10 and the line head 30.

The printer 20 is held in the body 5. The printer 20 includes a printing tank 22, a powder collector 23, a printing table 24, and a table raising and lowering device 25. The printer 20 includes a flat upper surface 21. The printing tank 22 and the powder collector 23 are arranged independently side by side such that the printing tank 22 and the powder collector 23 are recessed from the upper surface 21. The printing tank 22 is internally provided with the printing table 24 having a shape conforming to the bottom surface of the printing tank 22. The printing table 24 is provided such that no clearance is created between the printing table 24 and the inner side walls of the printing tank 22. A region surrounded by the printing tank 22 and the upper surface of the printing table 24 is a printing area. The powder material 2 is to be stored in the printing area where the three-dimensional object 3B is to be printed.

The printing table 24 is supported from below by the table raising and lowering device 25. The table raising and lowering device 25 is electrically connected to the controller 50. The table raising and lowering device 25 moves the printing table 24 in the up-down direction Z. The printing table 24 is raisable and lowerable in the up-down direction Z inside the printing tank 22. The table raising and lowering device 25 is not limited to any particular device. In the present preferred embodiment, the table raising and lowering device 25 is a cylinder mechanism. The table raising and lowering device 25 is an example of a conveyor to move the printing table 24 and the line head 30 (which will be described below) relative to each other in the up-down direction Z.

The powder collector 23 collects an excess portion of the powder material 2 fed to the printer 20. The powder collector 23 includes a space in which the excess portion of the powder material 2 is to be stored. The powder collector 23 is disposed on the front side F relative to the printing tank 22 in the front-rear direction X. The powder collector 23 is provided in its lower portion with a removal port (not illustrated) through which the powder material 2 collected is removed from the powder collector 23.

The conveyor 7 is held in the body 5. The conveyor 7 is provided on the bottom of the body 5. The conveyor 7 supports the printer 20. The conveyor 7 moves the printer 20 in the front-rear direction X inside the body 5. In other words, the conveyor 7 is an example of a conveyor to move the printing area relative to the line head 30 in the scanning direction X. The conveyor 7 includes guide rails 7G, a carriage 7C, and a drive motor 7M. The number of guide rails 7G is two. The guide rails 7G are disposed on the bottom of the body 5 such that the guide rails 7G extend in the front-rear direction X. The two guide rails 7G are disposed at a distance from each other in the right-left direction Y. The carriage 7C is in slidable engagement with the guide rails 7G. The printer 20 is secured onto the carriage 7C. The carriage 7C is connected to the drive motor 7M. The drive motor 7M is electrically connected to the controller 50. Rotating the drive motor 7M moves the carriage 7C along the guide rails 7G in the front-rear direction X.

The powder reservoir 10 includes a storage tank 12, a leg 14R, a leg 14L, and a stirrer 16. The storage tank 12 stores the powder material 2. The storage tank 12 is supported by the legs 14R and 14L such that the storage tank 12 is located on the upper side U relative to the printer 20. The storage tank 12 has a rectangular or substantially rectangular shape elongated in the right-left direction Y in a plan view. The length of the storage tank 12 in the right-left direction Y is equal or approximately equal to the length of the printing tank 22 in the right-left direction Y. The planar area of the storage tank 12 decreases as the storage tank 12 extends downward. The storage tank 12 has an inverted triangular or substantially triangular shape when viewed in cross section. The storage tank 12 includes an upper surface provided with an opening 12a. The storage tank 12 includes a lower end provided with a slit feed port 12b. Through the feed port 12b of the storage tank 12, the powder material 2 is discharged out of the storage tank 12 from the bottom of the powder reservoir 10.

The stirrer 16 to stir the powder material 2 is provided in a lower inner space of the storage tank 12 located on the upper side U relative to the feed port 12b. The stirrer 16 according to the present preferred embodiment is a rotary horizontal stirrer including a plurality of stirring blades 16a and a rotation shaft 16b. The rotation shaft 16b extends in the longitudinal direction of the storage tank 12. The stirring blades 16a extend radially with respect to the center of the rotation shaft 16b. Each stirring blade 16a is not limited to any particular shape. In one example, each stirring blade 16a may have any of various shapes, such as a paddle shape, an anchor shape, a turbine shape, a spiral shape, and a spool shape. The stirrer 16 is connected to a motor (not illustrated). The motor is electrically connected to the controller 50. Rotation of the rotation shaft 16b caused by the motor rotates the stirring blades 16a so as to stir the powder material 2. This increases fluidity of the powder material 2 so as to smoothly send the powder material 2 to the feed port 12b and discharge the powder material 2 through the feed port 12b. In one example, the stirrer 16 defines and functions as a rotary valve to discharge a predetermined amount of the powder material 2 from the storage tank 12.

The powder reservoir 10 may include, for example, a shutter (not illustrated) that slides so as to close the feed port 12b. In this case, the shutter is electrically connected to the controller 50. Providing the shutter in this manner prevents the powder material 2 from being accidentally discharged through the feed port 12b.

The legs 14R and 14L are disposed in the vicinity of the center of the body 5 in the front-rear direction X such that the legs 14R and 14L extend vertically or substantially vertically. The lower end of the leg 14R is secured to the right end of the body 5. The lower end of the leg 14L is secured to the left end of the body 5. The upper end of the leg 14R is secured to the right end of the storage tank 12. The upper end of the leg 14L is secured to the left end of the storage tank 12. The legs 14R and 14L support the storage tank 12 such that the storage tank 12 is located on the upper side U relative to the printer 20.

The powder material 2 that is a main constituent element of the three-dimensional object 3B may have any composition and shape. The powder material 2 may be powder made of any of various materials, such as a resin material, a metallic material, and an inorganic material. The powder material 2 may include powder that is a main constituent element of the three-dimensional object 3B. In one example, the powder material 2 may contain: a main component that is powder made of the material(s) mentioned above; and a secondary component that is a permeation promoter to promote permeation of a curing liquid (which will be described below) through the powder material 2. When the powder material 2 contains such a permeation promoter in advance, discharging a curing liquid onto the powder material 2 makes it possible to solidify the three-dimensional object 3B with high printing accuracy. In one example, the curing liquid may be water, and the permeation promoter may be a water-soluble permeation promoter. The curing liquid and the permeation promoter, however, are not limited to these materials or a combination thereof. The permeation promoter may be any other suitable permeation promoter. Examples of the permeation promoter include water-soluble high polymer materials, such as starch, polyvinyl alcohol (PVA), and polyvinyl pyrrolidone (PVP). Such a permeation promoter may be adhesive. The adhesive permeation promoter may function as a binder.

The line head 30 is a device from which the curing liquid to bind particles of the powder material 2 is discharged onto the powder material 2 in the printing tank 22. The line head 30 is disposed on the body 5 such that the line head 30 is located above the printer 20. In one example, the length of the line head 30 in the right-left direction Y may be longer than the length of the printing tank 22 in the right-left direction Y. The line head 30 is disposed such that the line head 30 extends over the printing tank 22 in the right-left direction Y. The line head 30 includes a lower surface 31 provided with a plurality of discharge holes through which the curing liquid is to be discharged. The discharge holes 32 of the line head 30 are arranged in a straight line in a first direction intersecting the scanning direction X. In the present preferred embodiment, the first direction corresponds to the right-left direction Y. In the present preferred embodiment, the line head 30 is provided with the discharge holes 32 aligned in four rows (i.e., rows a, b, c, and d) each extending in the right-left direction Y. The length of each of the rows a, b, c, and d of the discharge holes 32 is equal to the length (or width) of the printing area defined in the printing tank 22 in the right-left direction Y. In one example, the length of each of the rows a, b, c, and d of the discharge holes 32 may be equal to the length of a printable region of the printing area in the right-left direction Y. The rows a, b, c, and d of the discharge holes 32 are arranged in the scanning direction X. Aligning the discharge holes 32 in a plurality of rows (i.e., in the rows a, b, c, and d) increases accuracy in discharging the curing liquid from the line head 30. This makes it possible to print the three-dimensional object 3B with higher accuracy. Aligning the discharge holes 32 in the rows a, b, c, and d also increases the amount of curing liquid to be discharged in a single round of scanning. This makes it possible to print the three-dimensional object 3B having higher solidity.

As used herein, the term “straight line” refers not only to a straight line in a strict geometric sense but also to a row of dots that may be regarded as a substantially straight line. In one example, the discharge holes 32 aligned in the rows a, b, c, and d extending in the right-left direction Y may be deviated from each other by a distance approximately equal to or shorter than an interval (or pitch) between the discharge holes 32 when viewed in the front-rear direction X. The line head 30 is not limited to any particular configuration. The line head 30 may discharge the curing liquid in any mode. In one example, the line head 30 may discharge the curing liquid in an inkjet mode. The location of the line head 30 is adjusted such that a predetermined clearance is created between the lower surface 31 of the line head 30 and the upper surface 21 of the printer 20. In one example, a clearance of about 2 mm to about 3 mm is created between the lower surface 31 of the line head 30 and the upper surface 21 of the printer 20. The line head 30 is electrically connected to the controller 50. The controller 50 controls discharge of the curing liquid from the line head 30.

The discharge holes 32 are in communication with a curing liquid tank 33 through a tube (not illustrated). A liquid that binds together particles of the powder material 2 is used as the curing liquid. The curing liquid may be viscous. Examples of the curing liquid include water, liquid wax, and a liquid binder.

The air supplier 40 includes an air blower 42, a suction device 44, an air supply passage 46a, and an air supply passage 47a. The air supplier 40 supplies gas in a direction intersecting the direction of discharge of the curing liquid from the line head 30. In the present preferred embodiment, the air supplier 40 supplies gas in a direction perpendicular or substantially perpendicular to the direction of discharge of the curing liquid from the line head 30, i.e., in a direction perpendicular or substantially perpendicular to the downward direction D. In other words, the air supplier 40 produces an air current flowing in a direction parallel or substantially parallel to the lower surface 31 of the line head 30.

The air blower 42 is a device to blow air to the lower surface 31 of the line head 30. The air blower 42 is secured to the rear portion of the line head 30 through the air supply passage 46a. In one example, the air blower 42 includes a single or a plurality of fans. In the present preferred embodiment, the air blower 42 includes three relatively small fans disposed side by side in the right-left direction Y. This makes it possible to blow air to an entire portion of the lower surface 31 of the line head 30 extending in the right-left direction Y. The three fans of the air blower 42 are electrically connected to the controller 50. In one example, the controller 50 is configured or programmed to rotate the fans of the air blower 42 in a forward direction such that the air blower 42 blows air from the rear side Rr to the front side F in the scanning direction X. An air current produced by the air blower 42 preferably flows in a second direction intersecting the right-left direction Y (i.e., the first direction) in which the rows of the discharge holes 32 extend. Thus, the present preferred embodiment involves setting the orientation of the fans of the air blower 42 such that the fans of the air blower 42 face in the scanning direction X.

The suction device 44 is a device to suck surrounding gas (which is typically air) so as to move air present under the line head 30 to the suction device 44. The suction device 44 is secured to the front portion of the line head 30 through the air supply passage 47a. In one example, the suction device 44 includes a single or a plurality of fans. In the present preferred embodiment, the suction device 44 includes three relatively small fans disposed side by side in the right-left direction Y. This makes it possible to suck air from an entire region under the line head 30 extending in the right-left direction Y. The three fans of the suction device 44 are electrically connected to the controller 50. In one example, the controller 50 is configured or programmed to rotate the fans of the suction device 44 in a forward direction such that the suction device 44 moves air from the rear side Rr to the front side F in the scanning direction X. An air current produced by the suction device 44 preferably flows in the second direction intersecting the right-left direction Y (i.e., the first direction) in which the rows of the discharge holes 32 extend. Thus, the present preferred embodiment involves setting the orientation of the fans of the suction device 44 such that the fans of the suction device 44 face in the scanning direction X.

The air supply passage 46a is an air supply passage through which the air blower 42 is in communication with a space under the lower surface 31 of the line head 30. The air supply passage 47a is an air supply passage through which the suction device 44 is in communication with the space under the lower surface 31 of the line head 30. The air supply passages 46a and 47a each have a trapezoidal or substantially trapezoidal cross-sectional shape when viewed in the right-left direction Y. The length of each of the air supply passages 46a and 47a in the right-left direction Y is equal or substantially equal to the length of the line head 30 in the right-left direction Y. The air supply passages 46a and 47a each have a box shape in the form of a trapezoidal or substantially trapezoidal prism elongated in the right-left direction Y. The air supply passages 46a and 47a each have a tubular shape that is rectangular or substantially rectangular in cross section.

The air blower 42 is fitted to the rear lateral surface of the air supply passage 46a. The front end of the air supply passage 46a is connected to the lower end of a rear surface of the line head 30. The front portion of the lower surface of the air supply passage 46a is provided with an opening 46b in communication with the space under the line head 30. The suction device 44 is fitted to the front lateral surface of the air supply passage 47a. The rear end of the air supply passage 47a is connected to the lower end of a front surface of the line head 30. The rear portion of the lower surface of the air supply passage 47a is provided with an opening 47b in communication with the space under the line head 30. The upper surface of the air supply passage 46a is partially inclined toward the lower surface 31 of the line head 30, so that the area of the air supply passage 46a in cross section perpendicular to the scanning direction X gradually decreases as the upper surface of the air supply passage 46a extends toward the lower surface 31 of the line head 30 from the air blower 42. The upper surface of the air supply passage 47a is partially inclined toward the lower surface 31 of the line head 30, so that the area of the air supply passage 47a in cross section perpendicular to the scanning direction X gradually decreases as the upper surface of the air supply passage 47a extends toward the lower surface 31 of the line head 30 from the suction device 44.

The air supplier 40 according to the present preferred embodiment operates such that the suction device 44 sucks gas blown along the lower surface 31 of the line head 30 by the air blower 42. The air supply passages 46a and 47a are provided between the air blower 42 and the suction device 44. Thus, the gas blown by the air blower 42 and sucked by the suction device 44 becomes an air current flowing along the lower surface 31 of the line head 30 in the front-rear direction X. The air supply passages 46a and 47a decrease in cross-sectional area as the air supply passages 46a and 47a extend toward the lower surface 31 of the line head 30. This increases the velocity of the air current flowing along the lower surface 31 of the line head 30. The air supplier 40 according to the present preferred embodiment produces an air current flowing along the lower surface 31 of the line head 30 at a velocity between about 0.1 m/s and about 0.7 m/s inclusive or preferably at a velocity between about 0.3 m/s and about 0.5 m/s inclusive, for example. Because the air supplier 40 includes the air supply passages 46a and 47a, the air blower 42 and the suction device 44 may be relatively low in power, simple in structure, and light in weight. In one example, the air blower 42 and the suction device 44 according to the present preferred embodiment may each include a small fan that produces a maximum air volume of about 0.2 m³/min or less, for example.

The flattener 9 is a device to flatten the surface of the powder material 2, fed onto the printing table 24, so as to form a powder layer having a uniform or substantially uniform thickness. The flattener 9 forms the powder layer such that the surface of the powder material 2 is located at a preset height. The flattener 9 according to the present preferred embodiment is secured to the line head 30. The flattener 9 includes a squeegee roller 9a and a motor (not illustrated). The squeegee roller 9a has an elongated cylindrical shape. The squeegee roller 9a is disposed such that its axis extends in the right-left direction Y. The flattener 9 is supported by the line head 30 such that the squeegee roller 9a is located on the front side F relative to the line head 30 and the suction device 44. The length of the squeegee roller 9a in the right-left direction Y is longer than the length of the printing tank 22 in the right-left direction Y. The squeegee roller 9a is disposed such that the squeegee roller 9a extends over the printing tank 22. The lower end of the squeegee roller 9a is disposed slightly above the printer 20 such that a predetermined clearance (or gap) is created between the lower end of the squeegee roller 9a and the upper surface 21 of the printer 20 (i.e., the upper end of the printing tank 22). In one example, a clearance of about 0.5 mm to about 1 mm is provided between the lower end of the squeegee roller 9a and the upper surface 21 of the printer 20. The motor of the flattener 9 is electrically connected to the controller 50. The motor of the flattener 9 rotates the squeegee roller 9a in a forward direction or a reverse direction.

In the present preferred embodiment, the powder reservoir 10 and the line head 30 are secured to the body 5. The powder reservoir 10 and the line head 30 are disposed on the upper side U relative to the printer 20. As previously described, the air blower 42 and the suction device 44 of the air supplier 40 and the flattener 9 are disposed on the line head 30. The powder reservoir 10, the flattener 9, and the line head 30 are disposed in this order from the front side F in the scanning direction X. Thus, when the printer 20 is moved from the front side F to the rear side Rr in the scanning direction X by the conveyor 7, the printing tank 22 passes under the powder reservoir 10, the flattener 9, and the line head 30 in this order. Consequently, the powder material 2 is fed from the powder reservoir 10, the powder material 2 is flattened by the flattener 9, and the curing liquid is discharged from the line head 30 in a single round of scanning of the printing tank 22 from the front side F to the rear side Rr in the scanning direction X.

The controller 50 comprehensively controls operations of the components of the three-dimensional printing apparatus 1. The controller 50 is not limited to any particular configuration. The controller 50 is, for example, a microcomputer. The microcomputer is not limited to any particular hardware configuration. In one example, the controller 50 includes: an interface (I/F) to receive print data and other data from an external device, such as a host computer; a central processing unit (CPU) to execute a command of a control program; a read-only memory (ROM) storing the program or programs to be executed by the CPU; a random-access memory (RAM) to be used as a working area where the program(s) is to be expanded; and a storage device (memory) 54 storing various data, such as the control program(s).

FIG. 4 is a block diagram of the controller 50. The controller 50 includes a movement controller 51, a printing controller 52, an air supply controller 53, and the storage device 54. The functions of each component of the controller 50 may be implemented by hardware (e.g., a circuit and/or a microprocessor) or may be implemented by executing a computer program or programs by the CPU.

The movement controller 51 is electrically connected to: the drive motor 7M of the conveyor 7; and the table raising and lowering device 25 of the printer 20. This enables the movement controller 51 to control the drive motor 7M and the table raising and lowering device 25. The movement controller 51 drives the drive motor 7M of the conveyor 7 so as to move the printer 20 to the rear side Rr or the front side F in the scanning direction X. The movement controller 51 drives the table raising and lowering device 25 of the printer 20 so as to move the printing table 24 to the upper side U or the lower side D in the up-down direction Z.

The printing controller 52 is electrically connected to: the motor for the stirrer 16; the shutter of the powder reservoir 10; and the line head 30. This enables the printing controller 52 to control the motor for the stirrer 16, the shutter of the powder reservoir 10, and the line head 30. The printing controller 52 drives the motor for the stirrer 16 and the shutter of the powder reservoir 10 in such a manner that the motor and the shutter are driven independently or in conjunction with each other. Driving the motor and the shutter in this manner makes it possible to continuously discharge a predetermined amount of the powder material 2 downward through the feed port 12b. The printing controller 52 drives the line head 30 so as to discharge the curing liquid from predetermined one(s) of the discharge holes 32 of the line head 30 with predetermined timing.

The air supply controller 53 is electrically connected to the air supplier 40. The air supply controller 53 drives and stops the fans of the air blower 42 and the suction device 44. In other words, the air supply controller 53 causes the fans of the air blower 42 and the suction device 44 to switch between an ON state and an OFF state. The air supply controller 53 also controls the rotational direction of the fans in such a manner that the rotational direction is changed to the forward direction or the reverse direction when necessary. This makes it possible to produce, with desired timing, an air current flowing from the rear side Rr to the front side F in the scanning direction X along the lower surface 31 of the line head 30, and to produce, with desired timing, an air current flowing from the front side F to the rear side Rr in the scanning direction X along the lower surface 31 of the line head 30.

The three-dimensional printing apparatus 1 according to the present preferred embodiment prints the three-dimensional object 3B by following, for example, the procedure below. First, a user prepares printing data for the three-dimensional object 3B to be printed and stores the printing data in the storage device 54. The printing data includes a collection of cross-sectional shape data on each cross-sectional layer obtained when a model for the three-dimensional object 3B is cut into slices, each having a predetermined thickness, along any given plane. The cross-sectional shape data on each cross-sectional layer includes raster data, for example. Such printing data will be referred to as “slice data”. The direction of a plane vector of a slicing plane corresponds to a direction in which the cross-sectional layers are to be stacked during printing, i.e., the up-down direction Z. The thickness of each slice corresponds to the thickness of each cross-sectional layer during printing. In the present preferred embodiment, a mixture of alumina powder and water-soluble resin powder is used as a printing material (i.e., the powder material 2). The curing liquid used in the present embodiment is water. In the present preferred embodiment, “one-way printing” is performed to print the three-dimensional object 3B.

The controller 50 effects control such that the powder material 2 is fed onto the printing table 24. Specifically, the controller 50 first moves the printer 20 to the front side F in the front-rear direction X. The controller 50 then drives the table raising and lowering device 25 so as to adjust the height of the printing table 24 in the up-down direction Z such that the printing table 24 is located at a height suitable to start printing. In one example, when the first layer is to be printed, the height of the printing table 24 is preferably adjusted such that a printing start plane defined by the printing table 24 or the powder material 2 in the printing tank 22 is located lower than the upper surface 21 of the printer 20 by the thickness of the first layer. The controller 50 causes the squeegee roller 9a of the flattener 9 to rotate in the forward direction (which is the clockwise direction in FIG. 1).

The controller 50 drives the conveyor 7 so as to move the printer 20 from the front side F to the rear side Rr at a predetermined speed. The controller 50 causes the shutter of the powder reservoir 10 to slide so as to open the feed port 12b at the time when the front end of the printing tank 22 reaches a position under the feed slit 12b of the powder reservoir 10. The controller 50 actuates the stirrer 16 of the powder reservoir 10. Thus, the powder material 2 is fed to the printing tank 22 while the printer 20 is moved in the forward direction F. The powder material 2 is fed onto the printing table 24 little by little continuously such that the powder material 2 spreads from the front side F to the rear side Rr on the printing table 24. In other words, the powder material 2 is fed onto the moving printing table 24 such that the powder material 2 spreads all over the printing table 24. The amount of powder material 2 fed onto the printing table 24 is normally larger than the amount of powder material 2 necessary for formation of a single powder layer.

The controller 50 subsequently moves the printer 20 in the rearward direction Rr at a predetermined speed. This causes the printing tank 22 to pass under the flattener 9. Thus, the squeegee roller 9a flattens the upper surface of the powder material 2 fed onto the printing table 24. When the powder material 2 is fed excessively, the squeegee roller 9a prevents passage of an excess portion of the powder material 2. During passage of the printing tank 22 under the flattener 9, the squeegee roller 9a rotates, so that excessive compaction of the powder material 2 does not occur. Accordingly, the powder material 2 is spread on the printing table 24 such that the resulting layer has a predetermined thickness. As a result, the single powder layer is prepared.

The excess portion of the powder material 2 stopped by the squeegee roller 9a is transferred in the forward direction F relative to the printer 20 in accordance with movement of the printer 20 in the rearward direction Rr. The excess portion of the powder material 2 is eventually collected into the powder collector 23. Prior to this operation, the powder material 2 is fed onto the moving printing table 24 such that the powder material spreads all over the printing table 24. Thus, the present preferred embodiment prevents excessive compaction of the powder material 2 and occurrence of compaction variations during flattening and transfer of the powder material 2 by the squeegee roller 9a. Consequently, the powder layer prepared is more uniform in thickness, making it possible to effect printing with fewer dimensional errors.

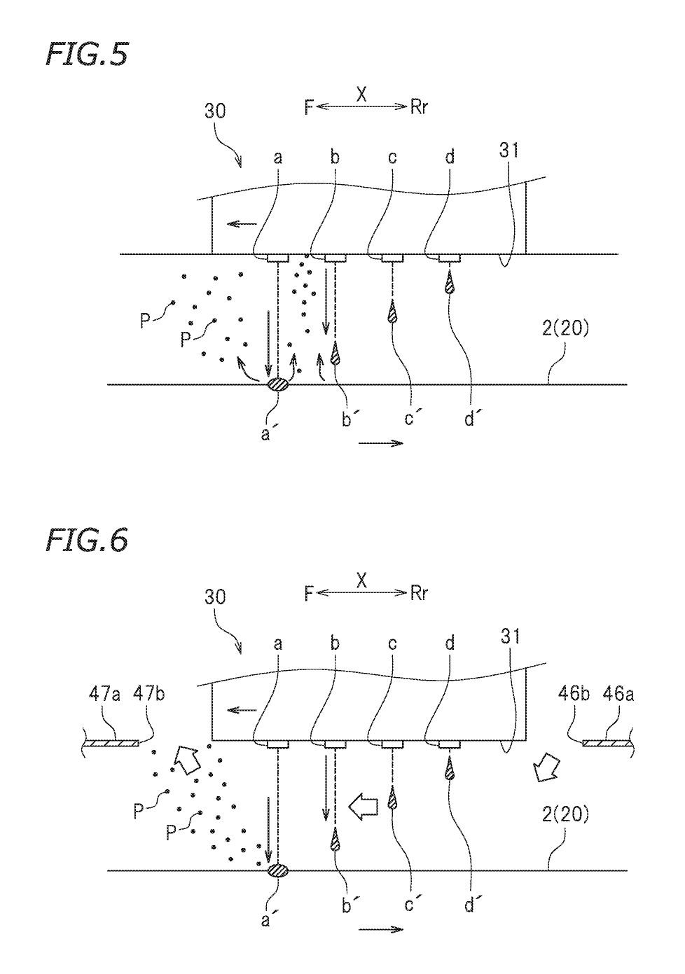

The controller 50 causes the printer 20 to move farther in the rearward direction Rr at a predetermined speed. Then, the printing tank 22 reaches a position under the line head 30. A technique known in the art involves causing the line head 30 to discharge the curing liquid in accordance with the slice data by the controller 50 while the controller 50 moves the printer 20 without driving the air supplier 40. In this case, the controller 50 does not cause the line head 30 to discharge the curing liquid simultaneously from the four discharge hole rows a, b, c, and d. In one example, as illustrated in FIG. 5, the controller 50 causes the line head 30 to discharge the curing liquid from the discharge hole rows a, b, c, and d in this order at predetermined intervals, while the controller 50 causes the line head 30 to move in the forward direction F relative to the printer 20. This enables the curing liquid, discharged from the rows a, b, c, and d, for example, to hit on the same position in the front-rear direction of the printer 20. Thus, the curing liquid is discharged with higher accuracy.

Studies conducted by the inventors reveal that the curing liquid discharged from the rows a, b, c, and d of the discharge holes 32 forms droplet rows a′, b′, c′, and d′ each extending in the right-left direction Y. Distances between the discharge holes 32 in each of the rows a, b, c, and d are sufficiently short, so that the droplet rows a′, b′, c′, and d′ fall onto a layer of the powder material 2 as if the droplet rows a′, b′, c′, and d′ each form a screen, for example. During this fall, momentum of the droplet rows a′, b′, c′, and d′ discharged from the line head 30 produces air currents flowing in the downward direction D beside the droplet rows a′, b′, c′, and d′. The air currents flowing in the downward direction D then hit against the powder material 2 so as to produce air currents flowing in the upward direction U. In this case, air current concentration results in relatively large currents flowing in the upward direction U between the droplet rows a′, b′, c′, and d′. Thus, when the curing liquid is discharged using a technique known in the art, the droplet rows a′, b′, c′, and d′ hitting on the powder material 2 cause particles P of the powder material 2 to swirl up, and the particles P swirling up are carried in the upward direction U by the air currents flowing in the upward direction U. Accordingly, when the curing liquid is discharged from the line head 30 using the technique known in the art, the swirling-up particles P of the powder material 2 are more likely to adhere to the lower surface 31 than when the curing liquid is discharged from a shuttle head. In particular, when the line head 30 includes the discharge hole rows a, b, c, and d, a larger amount of the powder material 2 inevitably adheres to the lower surface 31 of the line head 30. Typically, performing discharge scanning a few times (e.g., three times) using the line head 30 including the discharge hole rows a, b, c, and d causes the powder material 2 to adhere to the lower surface 31 of the line head 30 to such an extent that the powder material 2 adhering to the lower surface 31 is visually identifiable. The adhesion of the powder material 2 to the lower surface 31 of the line head 30 is particularly conspicuous when the powder material 2 is a material, such as gypsum, having a relatively small specific gravity (e.g., a specific gravity of about 6.5 g/cm³ or less, about 5 g/cm³ or less, about 3 g/cm³ or less, or about 2 g/cm³ or less).

Unlike the technique known in the art, the controller 50 of the three-dimensional printing apparatus 1 according to the present preferred embodiment drives the air supplier 40 at the time when the printing tank 22 reaches the position under the line head 30. Concurrently with this operation, the controller 50 causes the line head 30 to discharge the curing liquid in accordance with the slice data while moving the printer 20. Thus, as illustrated in FIG. 6, the suction device 44 sucks air blown from the rear side Rr to the front side F by the air blower 42, producing an air current flowing from the rear side Rr to the front side F in the scanning direction X along the lower surface of the line head 30. Accordingly, the particles P of the powder material 2 that swirl up when the droplet rows a′, b′, c′ and d′ hit on the powder material 2 are carried by the air current produced by the air supplier 40 and sucked by the suction device 44. This reduces or prevents adhesion of the powder material 2 to the lower surface 31 of the line head 30. Consequently, if the line head 30 is used, the three-dimensional printing apparatus 1 would be able to prevent occurrence of a defective condition, such as clogging of the discharge holes 32, in forming the first cross-sectional layer 3A on the printing table 24.

The controller 50 causes the shutter of the powder reservoir 10 to slide so as to close the feed port 12b, for example, at the time when the squeegee roller 9a reaches a position over the powder collector 23 of the printer 20. This completes a first layer printing step. Upon completion of the first layer printing step, the controller 50 may stop or continue driving the stirrer 16 of the powder reservoir 10, the motor that rotates the squeegee roller 9a, and the air supplier 40 individually. In the present preferred embodiment, the controller 50 stops driving the stirrer 16, the motor that rotates the squeegee roller 9a, and the air supplier 40 upon completion of the first layer printing step.

The three-dimensional printing apparatus 1 then prints the second and subsequent layers. Specifically, the controller 50 drives the conveyor 7 so as to move the printer 20 to the front side F in the front-rear direction X again. The controller 50 drives the table raising and lowering device 25 so as to adjust the height of the printing table 24 in the up-down direction Z such that the printing table 24 is located at a height suitable to start printing. In one example, when the second or subsequent layer is to be printed, the printing table 24 is moved downward by a distance corresponding to the thickness of the second or subsequent layer. Thus, a new printing space is defined on the printing table 24.

The controller 50 drives the conveyor 7 so as to move the printer 20 from the front side F to the rear side Rr at a predetermined speed. The controller 50 causes the shutter of the powder reservoir 10 to slide so as to open the feed port 12b at the time when the front end of the printing tank 22 reaches a position under the feed slit 12b of the powder reservoir 10. Simultaneously with this operation, the controller 50 actuates the stirrer 16 of the powder reservoir 10. Thus, the powder material 2 is fed into the newly defined printing space. The controller 50 rotates the squeegee roller 9a of the flattener 9 in the forward direction. Passage of the printing tank 22 under the squeegee roller 9a causes the powder material 2, fed into the printing space, to spread uniformly or substantially uniformly therethrough. Thus, a powder layer is prepared. Concurrently with passage of the printing tank 22 under the line head 30, the controller 50 drives the air supplier 40. This produces an air current flowing from the rear side Rr to the front side F along the lower surface 31 of the line head 30. The controller 50 causes the line head 30 to discharge the curing liquid onto the powder layer in accordance with the slice data. Consequently, the second cross-sectional layer 3A is formed on the first cross-sectional layer 3A such that the second cross-sectional layer 3A is integral with the first cross-sectional layer 3A.

A series of operations involving feeding the powder material 2, flattening the powder material 2, producing an air current, and discharging the curing liquid in the above-described manner is repeatedly performed in accordance with the number of cross sections included in the slice data. Thus, the cross-sectional layers 3A are stacked in the up-down direction Z such that the cross-sectional layers 3A are integral with each other. Consequently, the three-dimensional printing apparatus 1 prints the three-dimensional object 3B having a desired shape.

The air supplier 40 according to the present preferred embodiment produces an air current flowing from the rear side Rr to the front side F for reasons described below. The droplet rows a′, b′, c′, and d′ are respectively discharged from the discharge hole rows a, b, c, and d in this order at different times and then hit onto the powder material 2 in this order at different times. Suppose that the particles P of the powder material 2 swirling up when the first droplet row a′ hits on the powder material 2 are carried by an air current flowing from the front side F to the rear side Rr. In such a case, the particles P may adhere to the discharge holes 32 of the rows b, c, and d from which the curing liquid is to be discharged at later times. This may induce clogging of the discharge holes 32 or adversely affect accuracy in discharging the droplet rows b′, c′, and d′. Accordingly, it is not preferable to produce an air current flowing from the front side F to the rear side Rr.

Studies conducted by the inventors demonstrate that the air current produced by the air supplier 40 does not affect the accuracy in discharging the curing liquid from the line head 30 as long as the air current does not cause the powder material 2 to swirl up. The studies conducted by the inventors also demonstrate that adhesion of the powder material 2 to the lower surface 31 of the line head 30 is not visually identified even after discharge scanning is performed 50 times for printing that is assumed to require maintenance each time discharging scanning is performed three times, for example. Thus, the present preferred embodiment makes it possible to effect printing while reliably precluding adhesion of the powder material 2 to the lower surface 31 of the line head 30. The present preferred embodiment also prevents or reduces clogging of the discharge holes 32 of the line head 30. This considerably reduces the frequency of performing maintenance of the line head 30 and increases the lifetime of the line head 30.

In the present preferred embodiment, the line head 30 is used as a device to discharge the curing liquid. Thus, the curing liquid for each layer is discharged in a short time. This eventually considerably reduces the time required for printing the three-dimensional object 3B. Suppose that the mixture of alumina powder and water-soluble resin powder mentioned above, for example, is used as the powder material 2. In this case, the water-soluble resin powder in particular may promote clogging of the discharge holes 32 and may make it difficult to remove the powder material 2 attached to the lower surface 31 of the line head 30. The three-dimensional printing apparatus 1, however, precludes adhesion of the powder material 2 to the line head 30. Consequently, the three-dimensional printing apparatus 1 allows the user to perform printing and maintenance without concern for the properties of the powder material 2.

In the present preferred embodiment, the controller 50 is configured or programmed to drive the air supplier 40 when the controller 50 causes the line head 30 to discharge the curing liquid. For example, in the course of one-way printing, the controller 50 moves the printer 20 from the rear side Rr to the front side F without causing the line head 30 to discharge the curing liquid. During this operation, the controller 50 reliably prevents the surface of a portion of the powder material 2 onto which no curing liquid has been discharged from being accidentally disturbed by an air current produced by the air supplier 40.

In the present preferred embodiment, the air supplier 40 includes the air blower 42 secured to a portion of the line head 30 located on the rear side Rr in the second direction (i.e., the scanning direction X in the present preferred embodiment). The air blower 42 blows air from the rear side Rr to the front side F. Thus, the air supplier 40 efficiently produces an air current flowing from the rear side Rr to the front side F along the lower surface 31 of the line head 30. The air supplier 40 further includes the suction device 44 secured to a portion of the line head 30 located on the front side F in the second direction (i.e., the scanning direction X in the present preferred embodiment). The suction device 44 sucks air from the rear side Rr to the front side F. Thus, the air supplier 40 suitably transfers the particles P of the powder material 2, carried by the air current, to a region where the particles P do not adversely affect printing accuracy. This is preferable because the particles P would be reliably transferred toward the suction device 44 if, for example, the powder material 2 used is relatively heavy powder made of at least one of an inorganic material and a metallic material instead of a relatively light resin material.

In the present preferred embodiment, the air supplier 40 includes: the tubular air supply passage 46a connected to the air blower 42 and extended toward the lower surface 31 of the line head 30; and the tubular air supply passage 47a connected to the suction device 44 and extended toward the lower surface 31 of the line head 30. The distance between tube walls of the air supply passage 46a gradually decreases as the air supply passage 46a extends toward the lower surface 31 of the line head 30 from the air blower 42. The distance between tube walls of the air supply passage 47a gradually decreases as the air supply passage 47a extends toward the lower surface 31 of the line head 30 from the suction device 44. Thus, the space defined by the air supply passages 46a and 47a, the lower surface 31 of the line head 30, and the layer of the powder material 2 provides a “venturi tube structure”. Consequently, the air supplier 40 efficiently produces a relatively large air current flowing along the lower surface 31 of the line head 30, while reducing the flow rate of gas blown from the air blower 42 and sucked by the suction device 44.

The three-dimensional printing apparatus 1 according to the present preferred embodiment includes the powder reservoir 10 storing the powder material 2. The powder reservoir 10 is located on the upper side U relative to the printing table 24. The powder reservoir 10 includes the storage tank 12 and the stirrer 16. The storage tank 12 stores the powder material 2. The storage tank is provided at its lower end with the feed port 12b. The stirrer 16 is provided in the storage tank 12. The stirrer 16 stirs the powder material 2. This arrangement enables the powder material 2 to be fed across the printing table 24 directly from the powder reservoir 10. This makes it unnecessary to feed the powder material 2 onto the printing table 24 while transferring an entire portion of the powder material 2 corresponding to a single layer, for example, such that the powder material 2 evenly spreads. Accordingly, the present preferred embodiment allows the user to prepare a layer of the powder material 2 with small variations in density or compactness. The present preferred embodiment prevents degradation in the powder material 2 in reusing a portion of the powder material 2 onto which no curing liquid has been discharged and which has not been used to print the three-dimensional object 3B.

The three-dimensional printing apparatus 1 according to the present preferred embodiment includes a supporting member (which is the body 5 in the present preferred embodiment) supporting the powder reservoir 10 and the line head 30 such that the positions of the powder reservoir 10 and the line head 30 relative to each other remain unchanged. The powder reservoir 10 is disposed on the front side F relative to the line head 30 in the scanning direction X. Use of the line head 30 having a length equal to or substantially equal to the width of a printing region enables the curing liquid to be discharged onto a wide area with a single round of scanning. This makes it possible to feed the powder material 2 and discharge the curing liquid during the same scanning. Consequently, the time required for printing in the present preferred embodiment is considerably shorter than when a shuttle head that is in wider use and requires movement in the width direction is used.

The three-dimensional printing apparatus 1 according to the present preferred embodiment includes the flattener 9 to uniformly or substantially uniformly flatten the surface of the powder material 2 fed onto the printing table 24. The flattener 9 is secured to the line head 30. The flattener 9 is disposed on the front side F relative to the air supplier 40 in the scanning direction X when the line head 30 moves relative to the printing table 24 while discharging the curing liquid onto the printing table 24. In this arrangement, the positions of the flattener 9, the line head 30, and the air supplier 40 relative to each other are held constant. Thus, a series of operations including flattening the powder material 2 and discharging the curing liquid is reliably carried out in a single round of scanning.

Although the preferred embodiments of the present invention have been described thus far, the preferred embodiments described above are only illustrative. The present invention may be embodied in various other forms.

The three-dimensional printing apparatus 1 according to the present preferred embodiment effects one-way printing involving discharging the curing liquid only when the line head 30 moves relative to the printing table 24 in one of the first and second scanning directions, and the air supplier 40 produces only air current(s) flowing from the rear side Rr to the front side F. The three-dimensional printing apparatus 1, however, is not limited to this configuration. In one example, the three-dimensional printing apparatus 1 may effect “two-way printing” involving discharging the curing liquid not only when the line head 30 moves relative to the printing table 24 in one of the first and second scanning directions but also when the line head 30 moves relative to the printing table 24 in the other one of the first and second scanning directions. During two-way printing, while discharging the curing liquid, the line head 30 scans the printing table 24 by moving relative to the printing table 24 in the first scanning direction (e.g., the forward direction F) and in the second scanning direction (e.g., the rearward direction Rr). Although not essential, the controller 50 may drive the air supplier 40 not only when the line head 30 scans the printing table 24 in the forward direction F but also when the line head 30 scans the printing table 24 in the rearward direction Rr. When the controller 50 drives the air supplier 40 while the line head 30 scans the printing table 24 in the rearward direction Rr, the controller 50 changes the rotational direction of each fan of the air blower 42 and the suction device 44 to the reverse direction so as to control the suction device 44 and the air blower 42 in a manner described below. The controller 50 causes the suction device 44 to blow air from the front side F to the rear side Rr, so that the air reaches the lower surface 31 of the line head 30. The controller 50 causes the air blower 42 to suck air from the front side F to the rear side Rr, so that the air, which has been blown by the suction device 44 and has reached the lower surface 31 of the line head 30, is sucked in the rearward direction Rr. Such control makes it possible to produce an air current flowing from the front side F to the rear side Rr along the lower surface 31 of the line head 30. This prevents the powder material 2 from adhering to the lower surface 31 of the line head 30 also when the line head 30 discharges the curing liquid while scanning the printing table 24 in the second scanning direction (i.e., the rearward direction Rr).

The three-dimensional printing apparatus 1 according to the present preferred embodiment is structured such that the line head 30 is secured to the body 5, and the conveyor 7 moves the printer 20, including the printing table 24, relative to the line head 30 in the scanning direction X. The three-dimensional printing apparatus 1, however, is not limited to this configuration. In an alternative example, an entirety of the printer 20, including the printing table 24, may be secured to the body 5, and the line head 30 may be movable relative to the printing table 24 in the scanning direction X by the conveyor 7. In such an example, not only the air supplier 40 but also the flattener 9, for example, may be secured to the line head 30. The powder reservoir 10 and the line head 30 may be integral with each other. The three-dimensional printing apparatus 1 may be structured such that an entirety of each of the powder reservoir 10, the flattener 9, the air supplier 40, and the line head 30 is movable relative to the printer 20 in the scanning direction X by the conveyor 7. Such a configuration also achieves effects similar to those described above.

To facilitate the understanding of the configuration of the three-dimensional printing apparatus 1 according to the present preferred embodiment, the position of the powder reservoir 10 in the up-down direction Z is higher than the position of the line head 30 in the up-down direction Z. The powder reservoir 10, however, may be located at any other position in the up-down direction Z. The legs 14R and 14L may each have any length in the up-down direction Z as long as the storage tank 12 is disposed on the upper side U relative to the printer 20. In one example, the position of the storage tank 12 in the up-down direction Z may be lowered such that the storage tank 12 and the line head 30 are located at the same or substantially the same height. This reduces or prevents swirling-up of the particles P of the powder material 2 when the powder material 2 is discharged downward. Consequently, adhesion of the powder material 2 to the line head is more effectively reduced or prevented, resulting in a reduction in the burden of repair and maintenance of the line head 30.

In the present preferred embodiment, the position of the powder reservoir 10 in the up-down direction Z is higher than the position of the printer 20 in the up-down direction Z. The powder reservoir 10, however, may be located at any other position in the up-down direction Z. In an alternative example, the powder reservoir 10 may be provided in the form of a tank recessed from the upper surface 21 of the printer 20 and disposed side by side with the printing tank 22. In such an example, the storage tank 12 of the powder reservoir 10 is preferably provided independently such that the storage tank 12 is disposed opposite to the powder collector 23 with respect to the printing tank 22. In one example, the powder reservoir 10 may include: the storage tank 12 having a box shape; a pushing-out table having a shape conforming to the bottom surface of the storage tank 12; and a pushing-out table raising and lowering device to move the pushing-out table in the up-down direction Z. The pushing-out table raising and lowering device raises the pushing-out table so as to push out the powder material 2 upward from the upper surface 21 of the printer 20. The powder material 2 pushed out is transferred by the flattener 9 and is thus fed onto the printing table 24. Similarly to the foregoing preferred embodiment, such a preferred embodiment reduces or prevents adhesion of the powder material 2 to the lower surface 31 of the line head 30.

The three-dimensional printing apparatus 1 according to the present preferred embodiment includes only one powder reservoir 10. Alternatively, the three-dimensional printing apparatus 1 may include two or more powder reservoirs 10. In this case, the powder reservoirs 10 may store the same powder material or two or more different powder materials. When the powder reservoirs 10 store two or more different powder materials, the three-dimensional printing apparatus 1 is able to print the three-dimensional object 3B using appropriate one(s) of the powder materials. Such a preferred embodiment makes it possible to print the three-dimensional objects 3B having various structures.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principle of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing apparatus comprising:
a printing table on which a powder material is to be placed;
a line head disposed above the printing table, the line head including a lower surface provided with a plurality of discharge holes from which a curing liquid to bind particles of the powder material is to be discharged;
a conveyor to move one of the printing table and the line head relative to the other one of the printing table and the line head in a scanning direction;
an air supplier disposed on the line head; and
a controller configured or programmed to control driving of the air supplier; wherein
the discharge holes of the line head are disposed in a straight line in a first direction intersecting the scanning direction; and
the air supplier supplies air to the lower surface of the line head in a second direction intersecting the first direction such that the air is supplied from a rear side to a front side in the scanning direction when the line head moves relative to the printing table while discharging the curing liquid.

2. The three-dimensional printing apparatus according to claim 1, wherein the controller is configured or programmed to drive the air supplier when the controller causes the line head to discharge the curing liquid.

3. The three-dimensional printing apparatus according to claim 1, wherein the air supplier includes an air blower secured to a portion of the line head located on the rear side in the second direction, and the air blower blows air from the rear side to the front side.

4. The three-dimensional printing apparatus according to claim 3, wherein the air supplier includes a suction device secured to a portion of the line head located on the front side in the second direction, and the suction device sucks air from the rear side to the front side.

5. The three-dimensional printing apparatus according to claim 4, wherein
the air supplier includes a first air supply passage having a tubular shape and a second air supply passage having a tubular shape, the first air supply passage being connected to the air blower and extended toward the lower surface of the line head, the second air supply passage being connected to the suction device and extended toward the lower surface of the line head; and
a distance between tube walls of the first air supply passage decreases as the first air supply passage extends toward the lower surface of the line head from the air blower, and a distance between tube walls of the second air supply passage decreases as the second air supply passage extends toward the lower surface of the line head from the suction device.

6. The three-dimensional printing apparatus according to claim 1, further comprising a powder reservoir disposed above the printing table, the powder reservoir storing the powder material, wherein
the powder reservoir includes:
a storage tank storing the powder material and including a lower end provided with a feed port; and
a stirrer disposed in the storage tank to stir the powder material.

7. The three-dimensional printing apparatus according to claim 6, further comprising a support that supports the powder reservoir and the line head such that positions of the powder reservoir and the line head relative to each other remain unchanged, wherein
the powder reservoir is disposed forward of the line head in the scanning direction.

8. The three-dimensional printing apparatus according to claim 1, further comprising a flattener to uniformly or substantially uniformly flatten a surface of the powder material fed onto the printing table, wherein
the flattener is secured to the line head; and
the flattener is disposed forward of the air supplier in the scanning direction when the line head moves relative to the printing table while discharging the curing liquid.

9. The three-dimensional printing apparatus according to claim 1, wherein the powder material includes:
powder made of at least one of an inorganic material and a metallic material; and
a permeation promoter to promote permeation of the curing liquid to cure the powder material.
